(19) United States
(12) Patent Application Publication
(10) Pub. No.: US 2008/0202091 A1
(43) Pub. Date: Aug. 28, 2008

(54) Multi-purpose tool for attachment to a lawnmower

(76) Inventor: G. Douglas Bundy, Portland, OR (US)

Correspondence Address: KOLISCH HARTWELL, P.C., 520 SW YAMHILL STREET, Suite 200, PORTLAND, OR, 97204, US

(21) Appl. No.: 11/710,147

(22) Filed: Feb. 22, 2007

(51) Int. Cl. A01D 43/00

(52) U.S. Cl. 56/229

(57) ABSTRACT

A multi-purpose tool for mounting on a lawnmower to enable thatching, aerating or plugging includes a carrier for mounting to the handle of the lawnmower dimensioned to extend rearwardly therefrom and downwardly toward the ground. A rotatable plugger mechanism is connected to the carrier and includes an elongate, rotatable member dimensioned to extend at least partially across the ground, and a plurality of plugger tubes extend outwardly from the elongate member and are spaced apart for engaging the ground and receiving a portion of the soil therewithin when the lawn mower is pushed along the ground to rotate the elongate member.

### BACKGROUND AND SUMMARY OF THE INVENTION

The present invention relates to lawn care, and more particularly, to a novel attachment for a lawnmower, such as a lawnmower operated by a person while walking, to enable the lawn to be selectively aerated, thatched or “plugged.” Typically, it is recommended to aerate a lawn about half a dozen times per year, depending on the area of the country, and to plug the lawn, by creating cylindrical, hollow cores within the lawn, typically in the Spring and Fall. With respect to thatching, which may also be thought of as “de-thatching,” the process is to remove excess thatch, that is, the thick mat of clippings, cuttings and stems that may build up between blades of grass and the soil surface. Thatching is necessary because air, water, and light may not be able to reach the soil surface and it needs to be ripped out, thereby enabling healthy new grass shoots to grow. Conventionally, at last at the home lawn care level, a person can thatch a lawn by raking grass with a stiff-tined garden rake or the like to remove the thatch.

Concerning aeration, techniques such as “spiking” and “plugging” are commonly employed. Plugging refers to cutting a plug of soil from the ground, to allow moisture and nutrients to reach the root level for a healthier lawn, thereby reducing soil compaction to allow easier root growth. Another type of aerator method is the use of a “spiker,” which operates by penetration into the soil for poking small holes into the ground.

The prior art includes many different types of systems for plugging, spiking and de-thatching, but none provide a simple, multi-purpose accessory or tool which can be readily attached to the handle of a lawnmower and can be selectively adapted for performing any of the three above-mentioned lawn care procedures, namely, spiking, plugging, and de-thatching. The present invention is directed to providing such a multi-purpose tool, one which is of simple construction and is configured for easy, detachable mounting on the handles of a typical lawnmower, such as a lawnmower for use at one's home.

The present invention is rugged, operates relatively trouble-free and can be used by any home owner to help keep grass vibrant and healthy. When a lawn starts to take on a brown and lifeless look, or the soil becomes compacted, it calls for aeration which helps bring new life to a lawn. The aeration enables water, oxygen, and nutrients to reach the lawn's roots directly.

### BRIEF DESCRIPTION OF THE DRAWINGS

The principal features of the present invention will become more apparent from the following description in which reference is made to the appended drawings, wherein:

FIG. 1 is a perspective view, taken from the rear, of a lawnmower showing the tool of the present invention mounted to the spaced-apart arms of the lawnmower's handle, with the tool being adapted with a rotatable plugger mechanism;

FIG. 1A is a view similar to FIG. 1, where the rotatable plugger mechanism has been replaced with a rotatable spike wheel assembly for aeration;

FIG. 2 is a side elevation view, with portions cut away, illustrating action of the rotatable plugger mechanism;

FIGS. 3A-C illustrate, in an isolated view, a sequence showing the rotatable plugger mechanism as it penetrates into the soil and cuts out a plug which is removed;

FIG. 3D illustrates a portion of a plugger tube;

FIG. 4 is a side elevation view, with portions cut away, showing operation of the rotatable spike wheels for aeration;

FIG. 5 is a perspective view, taken from the rear, illustrating provision of multiple, spaced-apart, spring-loaded tines for thatching; and

FIG. 6 is a side elevation view, showing the action of the tines, as well as the rotatable spike wheel for a combined aeration/thatching operation.

### DETAILED DESCRIPTION OF THE PREFERRED EMBODIMENT

As stated in the outset, the present invention is directed to providing a multi-purpose attachment or tool, for detachable mounting on the handle of a lawnmower which enables lawn care in selective modalities, such as aeration using a rotatable plugger mechanism, aeration using a rotatable spike wheel assembly, and thatching, all for the purpose of facilitating healthy lawn growth. The present invention is directed to a relatively simple tool, which includes interchangeable components for facilitating plugging action, aeration using spike wheels and thatching using a plurality of tines.

### The Rotatable Plugger Mechanism

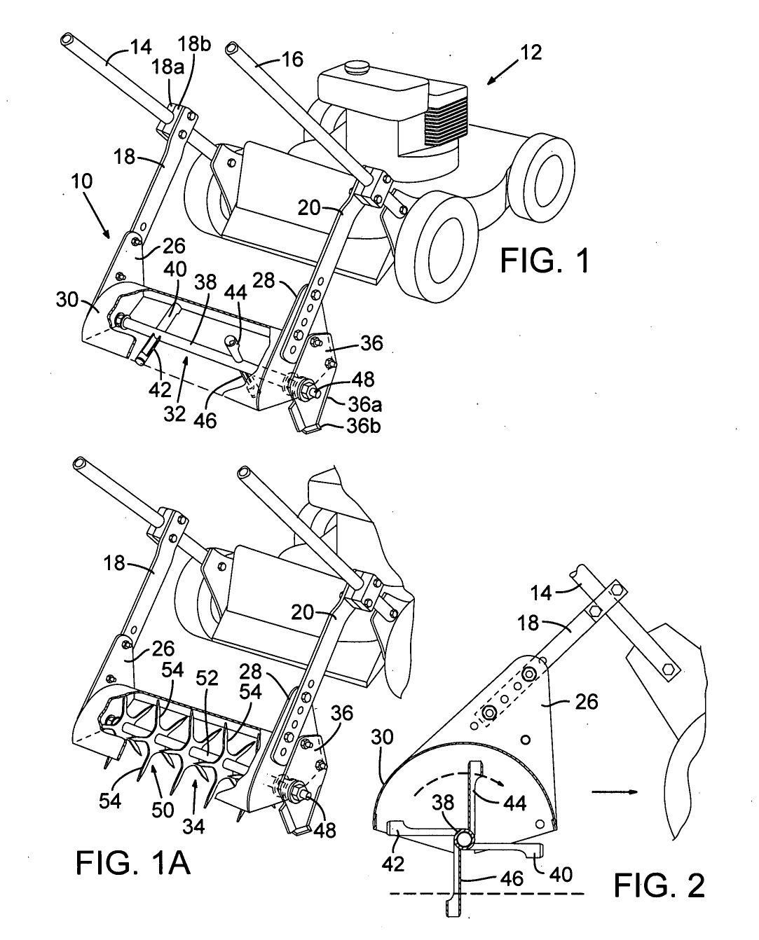

As shown in FIG. 1, a tool in accordance with the present invention is generally indicated at 10, detachably mounted on a lawnmower, generally indicated at 12. The lawnmower includes a pair of spaced-apart arms 14 and 16, suitably connected at their ends to brackets on the lawnmower. The arms are shown cut away, and the handlebar proper is not illustrated. Tool 10 is provided with a pair of spaced-apart mounting arms 18 and 20, each of which is provided with a pair of clamping members such as indicated at 18a, 18b which are clamped to the handlebar arms, such as arm 14, by means of bolts such as indicated at 22 and 24. A similar clamping construction is provided with respect to arm 20 of the tool.

It will also be noted that tool 10 is provided with spaced-apart brackets 26 and 28, which are suitably connected to arms 18 and 20, respectively, and these brackets in turn are formed as part of a carrier 30, formed to include a shield or guard. The carrier, as shown in FIG. 2, may be provided with an arcuate form, and is shown cut away in FIG. 1, for purposes of illustrating detachable components, such as a rotatable plugger mechanism, generally indicated at 32 in FIG. 1. As shown in FIG. 1A, a rotatable spike aerator mechanism is generally indicated at 34, and additionally, as shown in FIG. 1, an edger attachment is shown at 36, which includes sharpened edges 36a and 36b, provided for edging a lawn if deemed necessary.

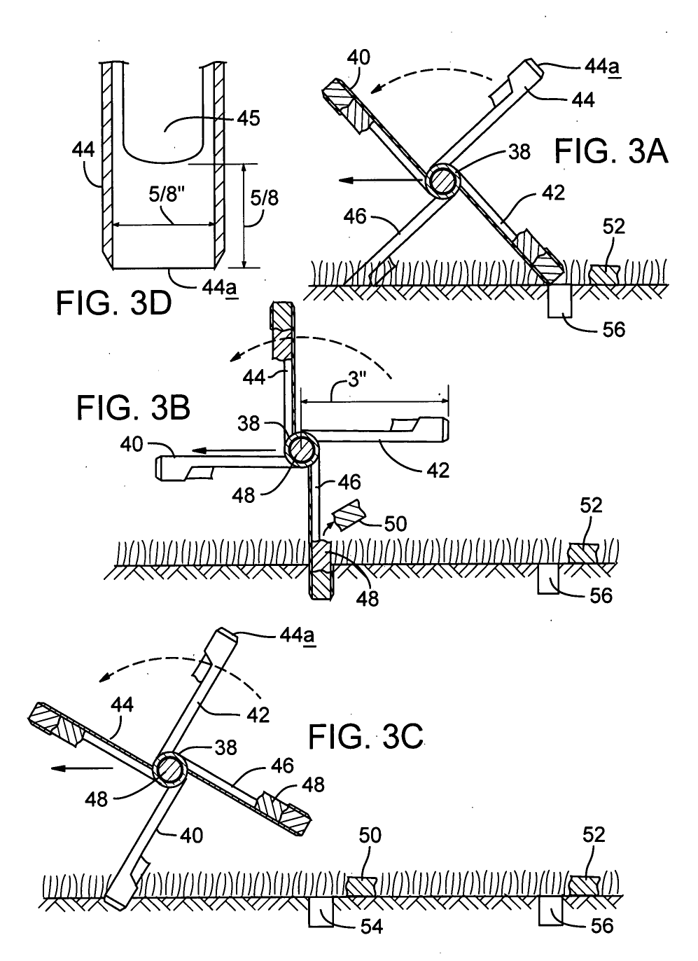

With respect to the rotatable plugger mechanism, generally indicated at 32 in FIG. 1, it will be noted that it includes a tubular member 38 which includes hollow plugger tubes rigidly mounted thereon, such as indicated at 40, 42, 44 and 46. The tubular member receives therethrough an elongate rod, which is suitably connected by a nut/washer arrangements to brackets 26 and 28, to enable tubular member 38, and its corresponding hollow plugger tubes, to rotate about a longitudinal axis defined by rod 48. As shown in FIG. 2, the plugger mechanism operates when the lawnmower is moved forward, and an individual presses down on the handle, thereby urging plugger tubes successively into the ground, and as shown in FIGS. 3A-3C, the ground is cored, with soil plugs cut from the ground and ejected, leaving a hollow core in the soil, thereby providing an area for aeration. As shown in FIG. 3A, assuming that the lawnmower is moving to the left, a plugger tube 42 has just removed a plug of soil, leaving a core, and plugger tube 46 is shown being driven into the ground, and in FIG. 3B is shown ejecting a plug, it being understood that a plug is only ejected from a plugger tube when a succeeding plug has been cut from the soil. For example, in FIG. 3B, plugger tube 46 is shown cutting a new plug 48 from the soil, while a previously cut plug 50 is shown being ejected from a previously cut plug 44. As shown in FIG. 3C, the rotatable plugger mechanism has moved further downstream, leaving a series of plugs, such as indicated at 50 and 52 on the ground, after having cut hollow cores such as indicated at 54 and 56. It is to be understood that the cutting action occurs in a staggered sequence, for example, as shown in FIG. 1, assuming that the lawnmower is moving to the right, plugger tube 46 will enter the ground first, to carve out a plug, and that is followed by plugger tube 40 next entering into the ground, this sequence is shown in FIGS. 3A-3C as well.

It has been found that by providing plugger tubes, which are arranged approximately 90-degrees from a corresponding plugger tube spaced-apart therefrom, that efficient plugging action can occur, it being understood that pressure to create the cutting action is caused by an individual who is pushing the lawnmower to push down on the lawnmower's handle, thereby operating the rotatable plugger mechanism so that its plugger tubes are pushed into the ground, in the sequence as shown in FIGS. 3A-3C. A further consideration of FIG. 3A will note that the plugger tubes do not radially extend from the longitudinal axis of tube 38, but are rather offset or cantilevered as shown. The plugger tubes, such as shown at 44, include a tubular section at the end thereof, which further includes a cutting edge such as indicated at 44a. Thus, as a plugger tube penetrates into the ground, and cuts downwardly into the soil, a plug will be urged upwardly through the hollow portion of the plugger tube, and will be ejected, in the sequence as shown in FIGS. 3A-3C.

The length of a plugger tube, including its stem portion may be in the general range of about 3-inches, as shown in FIG. 3B, and the plugger tube itself may be dimensioned about 5⅛-inch, with the total tubular-opening being in the range of ⅝-inches or thereabouts. As shown in FIG. 3D, the opening is shown at 45, in the enlarged depiction of the plugger shown in FIG. 3D.

### The Rotatable Spike Aerator Mechanism

The spike aerator of the present invention, which takes the form of a rotatable spike aerator mechanism, is generally shown at 34 in FIG. 1A. The rotatable spike aerator mechanism shown at 34 includes multiple spike wheels, one of which is generally indicated at 50. The spike wheels are generally-star shaped, and are rigidly connected to a tubular member 52 which receives rod 48, and which is rotatable along the rod's longitudinal axis, in the same manner as the rotatable plugger mechanism 32 (see FIG. 1). Each of the spike wheels, such as indicated at 50, is provided with a plurality of spaced-apart, radially extending “spikes,” such as indicated at 54.

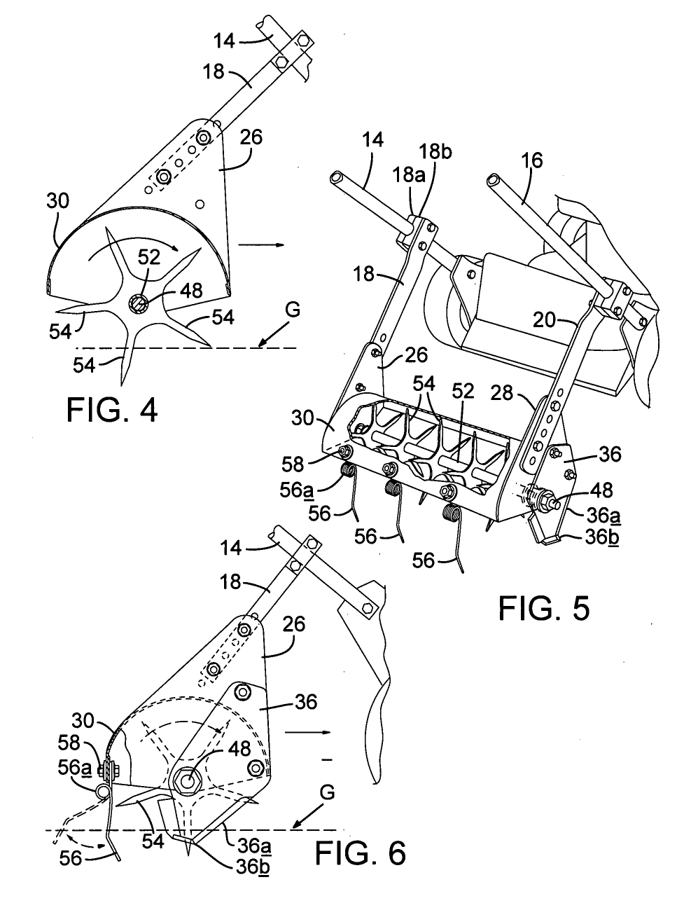

Each of the spikes is pointed or sharpened at an end, and each spike wheel is provided with an aperture for receiving tubular member 52, for rigid connection thereto. As an individual pushes the lawnmower along the ground, the spikes engage the ground and penetrate thereinto, successively, as the lawnmower moves forward and tubular member 52 rotates about the longitudinal axis of rod 48. This action is also shown in FIG. 4, where it can be seen that one of the spikes has already penetrated into the ground G, and as the lawnmower moves to the right, the next spike is just beginning to engage the ground, and will penetrate thereinto to be followed successfully by the other spikes on the spike wheel. Each of the spike wheels operate in the same manner, and because they are spaced apart along tubular member 52 as shown in FIG. 1A, a series of holes will be cut into the ground as the spikes successively penetrate. A plurality of spaced-apart holes will track along the path of each of the spiked wheels, and depth of penetration and speed can be regulated by the person pressing down on the lawnmower's handle, and the actual rate of speed that the individual chooses while walking.

### The Thatching Assembly

As mentioned previously, the present invention provides for a multi-purpose tool which includes the modality of enabling thatching, and this is accomplished by providing a plurality of elongate members, such as tines, mounted on the carrier/guard 30. As shown in FIG. 5, tines 56 include elongate metallic elements which are wound to form a spring at one end, such as indicated at 56a, and are secured by means of a bolt 58 to the carrier/guard 30. As shown in FIG. 6, as a lawnmower is pushed forwardly, and with pressure exerted downwardly on the handle by an individual, the spring-loaded tines can dig or cut at least partially into the ground for the thatching. The dashed lines in FIG. 6 show how the tines, which are biased forwardly, can penetrate into the ground to a depth predetermined by pressure exerted on the handle. It is this spring loading feature which enables selective penetration of the thatch. As shown in FIGS. 5 and 6, the tine assembly may be readily removed from the carrier/guard, so that it can be selectively used with the spike aerator mechanism or removed when it is desired to use the plugger mechanism.

From the above description, it should be apparent how the multi-purpose auxiliary tool of the present invention enables selective plugging, aerating and thatching to be accomplished. For example, it is possible to mow a lawn while aerating, by utilizing the rotatable plugger mechanism which is generally indicated at 32 in FIG. 1. It is simply a matter of attaching tube 38, with its attendant plugger tubes, and moving the lawnmower forward. Another modality is to simply mow and aerate, and that can be accomplished by the arrangement of mounting the spike aerator mechanism as shown in FIG. 1A. Still another modality is to mow, aerate and thatch, and that can be accomplished by the arrangement shown in FIGS. 5 and 6. As shown in FIG. 1, as well as some of the other figures, the edger attachment can also be mounted when it is required for an edging operation. Generally, an edger will only be used around the edge of a lawn, and the plugging, thatching and aerating mechanisms, and their various arrangements will be those which are principally employed.

I claim:

1. A multi-purpose tool for mounting on a lawnmower to enable thatching, aerating or plugging, comprising:
a carrier for mounting to the handle of the lawnmower dimensioned to extend rearwardly therefrom and downwardly toward the ground; and
a plugger mechanism connected to the carrier including an elongate, rotatable member dimensioned to extend at least partially across the ground, and a plurality of plugger tubes extending outwardly from the elongate member and spaced apart for engaging the ground and receiving a portion of the soil therewithin when the lawnmower is pushed along the ground to rotate the elongate member.

2. The multi-purpose attachment of claim 1 wherein the rotatable plugger mechanism is removable, and wherein the carrier is dimensioned for receiving a rotatable spike aerator mechanism, including a plurality of spaced-apart spike wheels mounted on a tubular member for engaging the ground and penetration thereinto during forward movement of the lawnmower and downward pressure on the lawnmower handle by a person pushing the lawnmower.

3. A multi-purpose attachment for mounting on a lawnmower to enable thatching and aerating, comprising:
a carrier for mounting to the handle of the lawnmower dimensioned to extend rearwardly therefrom and above the ground;
a spike aerator mechanism, including a plurality of spaced-apart spike wheels mounted on a tubular member for engaging the ground and penetration thereinto during forward movement of the lawnmower and downward pressure on the lawnmower handle by a person pushing the lawnmower; and
a plurality of spaced-apart spring-loaded tines extending downwardly from the carrier for engagement into the ground and for facilitating removal of thatch.

4. A multi-purpose attachment for mounting on a lawnmower to enable thatching and aerating, comprising:
a carrier for mounting to the handle of the lawnmower dimensioned to extend rearwardly therefrom and above the ground;
a plugger mechanism connected to the carrier including an elongate, rotatable member dimensioned to extend at least partially across the ground, and a plurality of plugger tubes extending outwardly from the elongate member and spaced apart for engaging the ground and receiving a portion of the soil therewithin when the lawnmower is pushed along the ground to rotate the elongate member;
a spike aerator mechanism, including a plurality of spaced-apart spike wheels mounted on a tubular member for engaging the ground and penetration thereinto during forward movement of the lawnmower and downward pressure on the lawnmower handle by a person pushing the lawnmower; and
a plurality of spaced-apart spring-loaded tines extending downwardly from the carrier for engagement into the ground and for facilitating removal of thatch.
